(19) United States
(12) Patent Application Publication
(10) Pub. No.: US 2023/0214478 A1
(43) Pub. Date: Jul. 6, 2023

(54) SYSTEM AND METHOD FOR SECURE CODE SCANNING

(71) Applicant: CenturyLink Intellectual Property LLC, Broomfield, CO (US)

(72) Inventors: Dean Ballew, Sterling, VA (US); John R.B. Woodworth, Amissville, VA (US)

(73) Assignee: CenturyLink Intellectual Property LLC, Broomfield, CO (US)

(21) Appl. No.: 17/958,794

(22) Filed: Oct. 3, 2022

Related U.S. Application Data
(60) Provisional application No. 63/295,051, filed on Dec. 30, 2021.

(51) Int. Cl. G06F 21/36; G06F 21/44; G06K 7/14; G06F 16/955

(52) U.S. Cl. CPC G06F 21/36; G06F 21/44; G06K 7/1417; G06F 16/9554; G06F 2221/2111; G06F 2221/2117

(57) ABSTRACT

Graphical codes, such as Quick Response (QR) codes, are commonly used for convenient acquisition by a mobile device of a text string (e.g., a Uniform Resource Locator identifying a website) or other data word. Such an acquisition, however, may be a relatively low-security operation because of the relative ease with which such graphical codes may be produced. As such, a system and method for secure code scanning and verification are provided.

### CROSS-REFERENCE TO RELATED APPLICATIONS

This application claims the benefit of U.S. Provisional Application No. 63/295,051 filed Dec. 30, 2021, entitled “System and Method for Secure Code Scanning,” which is incorporated herein by reference in its entirety.

### FIELD

One or more aspects of embodiments according to the present disclosure relate to code scanning, and more particularly to a system and method for secure code scanning.

### BACKGROUND

Graphical codes, such as Quick Response (QR) codes, are commonly used for convenient acquisition by a mobile device of a text string (e.g., a Uniform Resource Locator identifying a website) or other data word. Such an acquisition, however, may be a relatively low-security operation because of the relative ease with which such graphical codes may be produced.

It is with respect to this general technical environment that aspects of the present disclosure are related.

### SUMMARY

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

A system and method for acquiring a graphical code and assessing its authenticity is provided. In an aspect, a method is provided comprising acquiring a graphical code; transmitting the graphical code to a registry; receiving authenticity information for the graphical code from the registry; and using the authenticity information to perform an action.

In another aspect, a method is provided, comprising: acquiring a graphical code; generating an indication of authenticity for the graphical code by determining whether the graphical code is signed with a trusted signature; and using the indication of authenticity to perform an action.

In another aspect, a system is provided comprising at least one processor and memory, operatively connected to the at least one processor and storing instructions that, when executed by the at least one processor, cause the at least one processor to perform a method. In aspects, the method comprises: storing a registry of registered graphical codes; receiving a request to verify an acquired graphical code; and sending, in response to receiving the request to verify, authenticity information for the acquired graphical code.

### BRIEF DESCRIPTION OF THE DRAWINGS

These and other features and advantages of the present disclosure will be appreciated and understood with reference to the specification, claims, and appended drawings wherein:

FIG. 1 is a block diagram of a system for secure code scanning, according to an embodiment of the present disclosure;

FIG. 2A is a flow chart of a method, according to an embodiment of the present disclosure;

FIG. 2B is a flow chart of a method, according to an embodiment of the present disclosure;

FIG. 2C is a flow chart of a method, according to an embodiment of the present disclosure;

FIG. 2D is a flow chart of a method, according to an embodiment of the present disclosure;

FIG. 2E is a flow chart of a method, according to an embodiment of the present disclosure;

FIG. 2F is a flow chart of a method, according to an embodiment of the present disclosure; and

FIG. 3 is a block diagram of an operating environment, according to an embodiment of the present disclosure.

### DETAILED DESCRIPTION

The detailed description set forth below in connection with the appended drawings is intended as a description of exemplary embodiments of a system and method for secure code scanning provided in accordance with the present disclosure and is not intended to represent the only forms in which the present disclosure may be constructed or utilized. The description sets forth the features of the present disclosure in connection with the illustrated embodiments. It is to be understood, however, that the same or equivalent functions and structures may be accomplished by different embodiments that are also intended to be encompassed within the scope of the disclosure. As denoted elsewhere herein, like element numbers are intended to indicate like elements or features.

Graphical codes, such as Quick Response (QR) codes, may be used in a wide variety of applications. For example, in a restaurant, customers may scan a graphical code (e.g., acquire an image of the graphical code with a camera of a mobile device) to navigate to a website that shows the restaurant's menu, and that may also allow a customer to order, and to pay for, food and beverages. As another example, a parking meter may have a graphical code affixed to it, which may allow a customer (e.g., a driver) to navigate to a page allowing the customer to pay for parking.

In such applications, security may be a concern. For example, a malicious actor may substitute an inauthentic graphical code (e.g., by substituting the inauthentic graphical code for an authentic graphical code), directing users (e.g., customers) to a website, operated by the malicious actor, that mimics a legitimate website and may, for example, attempt to obtain the customer's credit card number or other financial or private information. In some mobile devices, an application (or “app”) that scans the graphical code and converts it to a text string may, before navigating to a website, display the string to the user of the mobile device, and ask the user to confirm that the user wants to visit the corresponding website. Such a confirmation may offer relatively weak security, however, because (i) the website used by a malicious actor may have a Uniform Resource Locator (URL) selected by the malicious actor to be plausible (e.g., a URL containing the name of the restaurant or containing the string “parking-meters”) and (ii) authentic URLs may be ones that have been processed by a URL-length-reduction site, and the user may not readily be able to distinguish between processed URLs that are authentic and ones that are not.

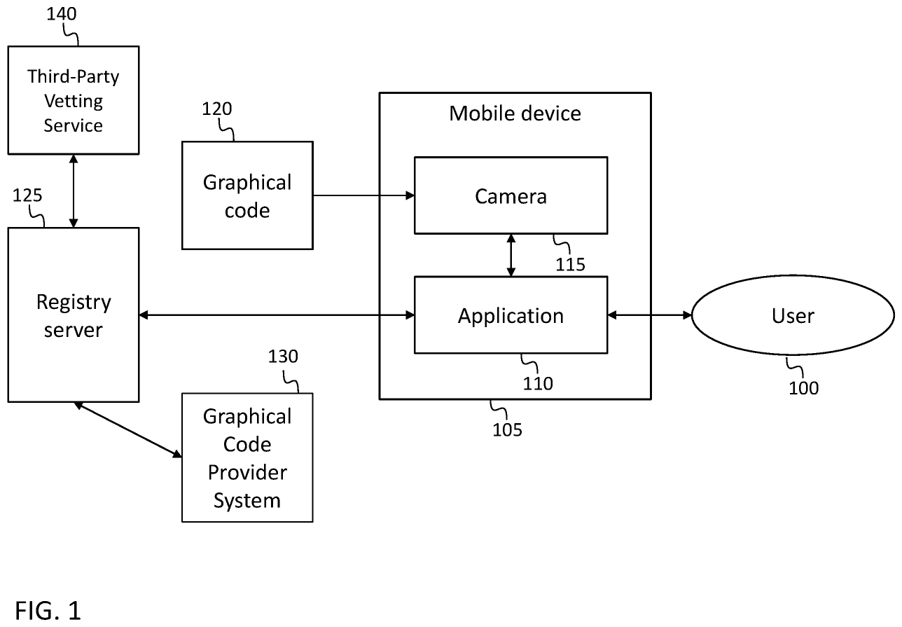

As such, in some embodiments, a mobile device may authenticate any scanned graphical code before taking further action, such as navigating to a URL identified by the graphical code or prompting the user whether to proceed to the corresponding website. Referring to FIG. 1, a user 100 who is in possession of a mobile device 105 may interact with an application 110 running on the mobile device 105. The application 110 may control a camera 115 of the mobile device 105 and cause the application to acquire an image of a graphical code 120. The application 110 may convert the graphical code 120 to a data word (e.g., to a text string, which may be a URL), and send the data word to a registry server 125 (which may maintain a registry of graphical codes) for authentication. The registry may, for example, comprise a database, service, application, or other system hosted on one or more registry server 125 that stores registration information that can be queried to determine the authenticity of graphical codes. The mobile device 105 may, for example, be connected to the registry server 125 through one or more networks, such as the Internet. In addition, although one registry server 125 is depicted, multiple, distributed registry servers 125 may be used. The application 110 may receive an indication of authenticity from the registry server 125 and proceed further according to the indication of authenticity. For example, if the indication of authenticity indicates with high confidence that the text string is an authentic URL, the application 110 may start a web browser in the portable device and instruct the browser to navigate to the URL. As another example, if the indication of authenticity indicates that the URL is known to have been used for fraudulent purposes, the application 110 may discard it, or allow the user to navigate to the URL only after having been warned that the URL is known or suspected to be inauthentic.

As used herein, a “data word” is a digital value, which may represent, e.g., an integer, a text string, or other data. As used herein, a graphical code 120 is “authentic” when it is what, from its circumstances, it purports to be, e.g., a URL to a website owned by the same entity as the entity that owns a restaurant within which the graphical code 120 is displayed. As used herein, the “authenticity” of a graphical code 120 is a measure of the confidence with which a graphical code 120 can be determined to be authentic.

The registry server 125 may store a plurality of data words, each corresponding to a graphical code, and, for each data word, data identifying the owner, and a geographic area, or “geographic region,” corresponding to the graphical code. The geographic region may be one within which the graphical code 120 is expected to be found, and within which graphical codes 120 owned by other entities are not expected to be found. Graphical code providers may register graphical codes 120 with the registry server 125 using, e.g., a graphical code provider system 130. Graphical code provider system 130 may comprise a computing device that is operatively connected (through one or more networks or otherwise) to the registry server 125. For example, if a restaurant (a graphical code provider) registers a graphical code, it may register it for, e.g., a geographic region having a radius of 50 feet, centered on a point near the center of the restaurant. To register the graphical code, an employee of the restaurant may, for example, hold a mobile device (in this instance, graphical code provider system 130) at a point near the center of the restaurant and submit, to the registry server 125, a graphical code registration request using a registration application to (i) scan the graphical code, (ii) enter identifying information for the owner, (iii) provide a graphical code definition (defining the graphical code or defining a family of graphical codes 120 (as discussed in further detail below)), and (iv) provide a definition of a geographic region (e.g., by entering a radius, if the geographic region is to be defined as a circular region centered on the location of the mobile device). In some examples, graphical code provider system 130 may comprise the same or similar mobile device 105 that can be used to consume and check the veracity of graphical codes, as explained further herein. In other examples, one or more separate graphical code provider system 130 may be used to register graphical code(s) 120 with registry server 125. The registration process performed using graphical code provider system 130 may be facilitated by an application resident on the graphical code provider system 130, by a portal hosted by registry server 125, or by any other means by which the necessary registration information may be communicated to the registry server 125 for a new or updated graphical code registration.

Various methods may be employed by the registry server 125 for vetting registration requests before registering the associated graphical codes 120, to ensure reliability, and to reduce the likelihood that a malicious actor may register an inauthentic graphical code 120. For example, after the registration request is submitted, a third-party vetting service 140 may perform various checks (e.g., checks with financial institutions, checks of real estate records, site visits, or the like) to confirm that a purported owner of an asset (e.g., a restaurant or a parking meter) to be associated with a graphical code 120 is legitimate. In some embodiments, a voting or rating system may be used, which may rely on input from users (e.g., users confirming successful interactions with certain graphical codes 120 through application 110, or users reporting that certain graphical codes 120 are inauthentic through application 110 or otherwise), or public records may be used by registry server 125 or third-party vetting service 140 to confirm that an entity with a certain name exists at or near a geographic region for which the entity seeks to register a graphical code.

The registering of a graphical code 120 may involve setting up an account with the registry server 125 (with a login name and password), and the existence of a conflicting registration (made through another account) may be a factor weighing against the registering of a new graphical code. Charging a fee for each registration (e.g., a fee proportional to the size of the geographic region for which the graphical code 120 is to be registered) may also help to ensure reliability, as malicious actors may be reluctant to gamble funds in the face of uncertainty regarding whether they will succeed. In some circumstances, the registration of multiple graphical codes 120 to multiple respective owners with overlapping geographic regions may indicate that some or all of the graphical codes 120 are not authentic; for example, different businesses may have an overlapping footprint if they are located on different floors of a multi-story building. In such a case the vetting process may result in the registration of several such overlapping graphical codes 120 by taking other factors, weighing in favor of the authenticity of the graphical codes, into account. In some embodiments, graphical codes 120 that are customer-portable (e.g., graphical codes 120 on movie tickets) may be registered for a large geographic region (e.g., a metropolitan area within which they may be expected to be carried by customers), or such graphical codes 120 may be registered without specifying an area.

Each registration in the registry maintained by registry server 125 may be for a single graphical code 120 or for a plurality, or “family” of related graphical codes. For example, a restaurant may register a different respective graphical code 120 for each table in the restaurant, so that when a customer places an order after navigating to a URL encoded in the graphical code 120, the web server receiving and processing the order may be aware of which table the order is to be delivered to. Similarly, in a parking lot with a plurality of parking meters (or with a plurality of parking spots, each having a graphical code 120 affixed to a sign at the parking spot) each parking spot may have a different respective graphical code. In such a situation, each graphical code 120 may include, for example, at the end of the URL, a variable-defining string such as “?tableNumber=5” or “?spotNumber=23”; this may inform the server, when a customer accesses the URL encoded in the graphical code 120, that the customer is at table 5 or has parked in parking spot 23, respectively. The family of graphical codes 120 with all possible valid values for the variable defined by the variable-defining string may be registered in a single registry entry. For example, wild cards may be included in a URL sent with a registration request by graphical code provider system 130, or the family of text strings to be registered may be represented as a regular expression, or the registry entry may be simply a domain, and the registry may be configured to consider as registered any URL within the domain (e.g., beginning with the name of the registered domain). In some embodiments, at the time of registration, the registry server 125 generates, returns to the graphical code provider system 130, and registers in the registry, a reduced-length data word (e.g., a reduced-length URL). It may also return to the graphical code provider system 130 a graphical code representing this reduced-length URL (or a signed graphical code representing this URL, as discussed in further detail below).

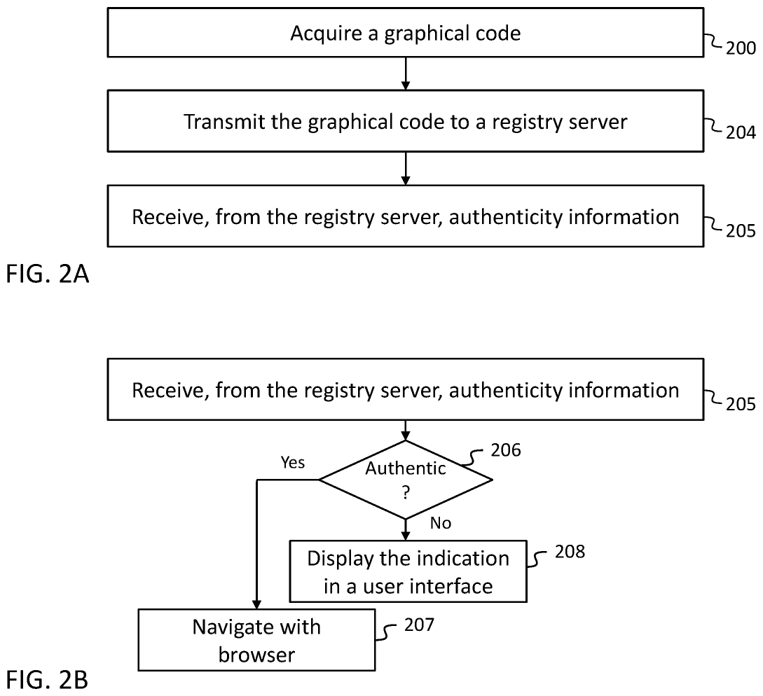

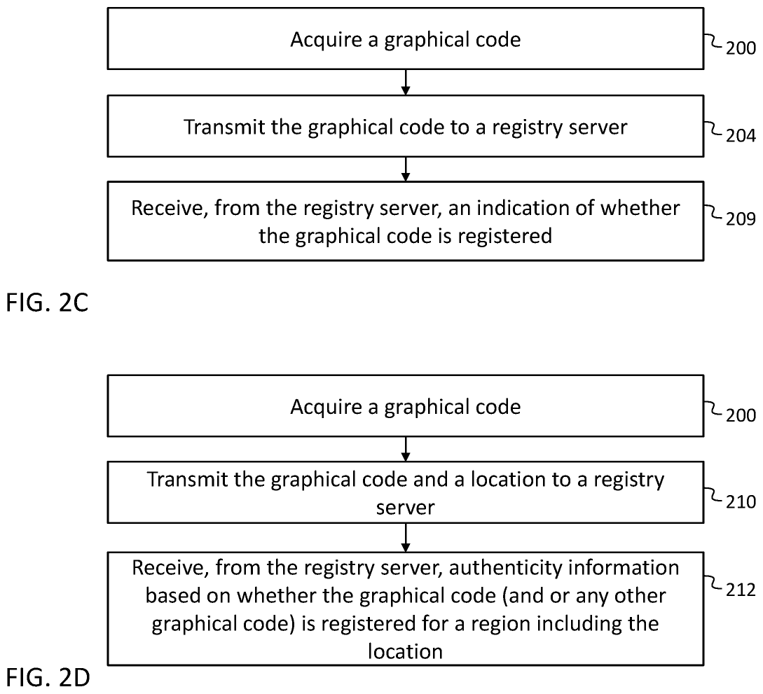

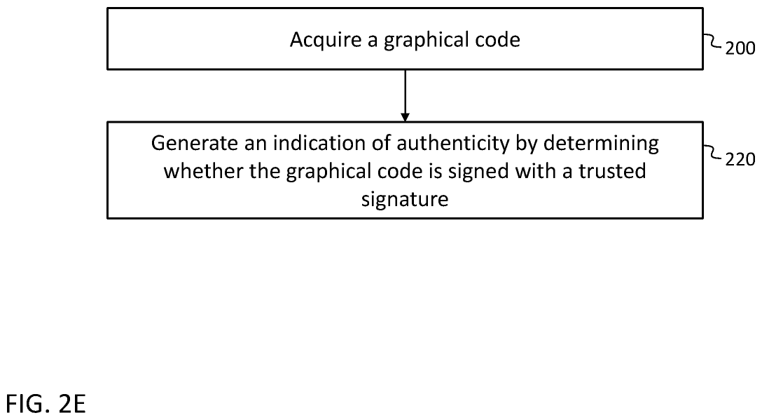

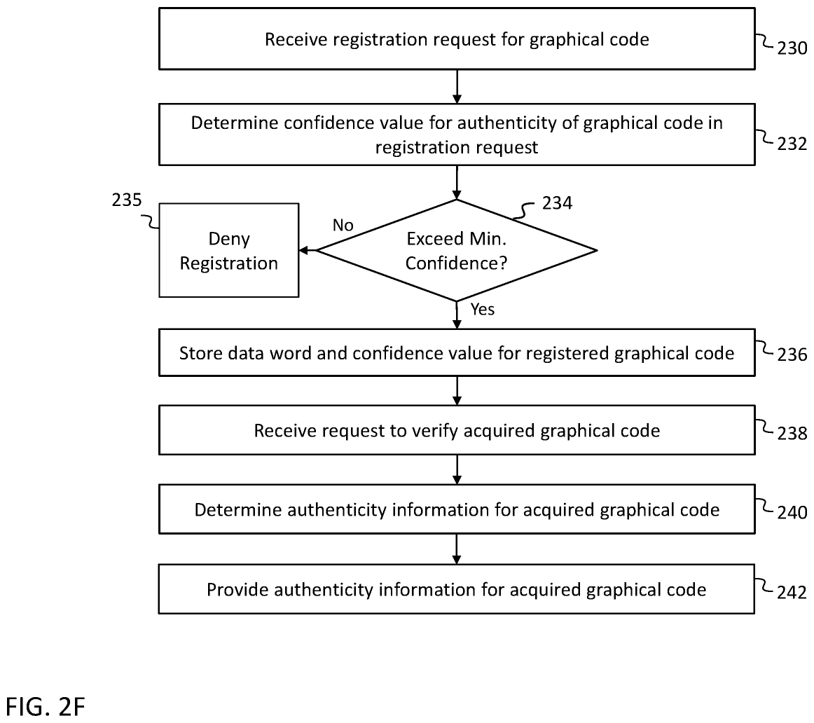

FIG. 2A is a flowchart illustrating the use of the registry, in some embodiments. In examples, some or all of the operations of FIGS. 2A-2E may be performed by mobile device 105. In some examples, certain operations of FIGS. 2A-2E may be performed by one or more registry server 125. In operation, when a user (as mentioned above) scans or otherwise captures (e.g., using a camera 115 of mobile device 105), and a graphical code 120 is acquired, at 200, the application 110 may, at 204, transmit the graphical code 120 to the registry (e.g., by transmitting it to the registry server 125) for authentication, and authenticity information may be received, at 205. As used herein, an “indication of authenticity” may comprise a measure of the confidence with which a graphical code 120 can be determined to be authentic (or inauthentic), or an estimate of the likelihood that a graphical code 120 is authentic (or inauthentic). As used herein, “authenticity information” is either an indication of authenticity or information (e.g., registration information received from a registry) based on which an indication of authenticity may be generated.

Referring to FIG. 2B, after receiving, at 205, the authenticity information (as described above), a determination is made at operation 206 whether the authenticity information indicates that the code is likely authentic. In examples, a minimum threshold of authenticity may be defined and may comprise a predetermined and/or user-settable threshold in the application 110 (e.g., accept as authentic only if the indication of authenticity is “high” or over X %). For example, the received authenticity information comprises an indication of authenticity from the registry server 125, a comparison determination may be made whether the indication of authenticity provided by the registry server 125 meets a minimum threshold level of confidence for authenticity. In examples, the registry may determine the indication of authenticity based on a variety of factors (discussed above and hereinafter), including whether the code is registered, whether the code is registered for or near a location in which the code was captured, whether other codes are registered in or near the location in which the code was captured, whether other users have approved the use of the code, etc. In some examples, the application may receive from the registry server 125 only information about the code (e.g., whether it is registered, other registrations for the location where the code was acquired, etc.), which the application 110 may use to make its own determination of an indication of authenticity. In examples, the application-derived determination of authenticity may be compared to the predetermined or user-settable minimum threshold of confidence for authenticity in order to make the determination of operation 206.

If a determination is made at operation 206 that the code is likely authentic (e.g., exceeds a minimum threshold of confidence for authenticity), flow proceeds “yes” to operation 207, where a browser or other application may be caused to navigate to a website indicated by the graphical code. For example, in the restaurant example, when the code is executed, a browser on the mobile device 110 may be caused to navigate to a menu or payment application for the restaurant. If operation 206 determines that the code is not likely authentic (or the indication of authenticity determined by the registry or by the application 110 does not meet a minimum threshold level of confidence for authenticity), then flow branches “no” to operation 208. In examples, operation 208 may comprise causing the indication that the code is inauthentic to be displayed in a user interface on mobile device 110 (e.g., in a user interface of application 110 or otherwise). In examples, the user interface may give the user an opportunity to override the determination of inauthenticity and continue to the website represented by the graphical code. In examples, operation 208 may also comprise sending a notification to the registry. For example, the registry may keep track of codes that are checked against the registry and determined to be inauthentic. The registry may also track codes that are determined to be inauthentic, but the determination is overridden by the user. Such information may be used by the registry in making future determinations of authenticity for particular codes, as needed.

Other examples are illustrated in FIGS. 2C-2E. For example, in FIG. 2C, as described above, the graphical code is similarly acquired at operation 200 and transmitted at operation 204 to the registry server 125. In this example, the registry server 125 provides, and the application 110 receives at operation 209, an indication whether the graphical code is registered. Flow may then proceed from operation 209 to operation 206 and subsequent operations described with respect to FIG. 2B. In this example, the authenticity information is simply an indication of whether the code is registered. The determination made at operation 206 (e.g., by the application 110) may then be a simple yes/no determination of whether the code is registered and, if so, the code is deemed authentic. In other examples, the determination at operation 206 may include a gating question of whether the code is registered, and then the application 110 may, itself, acquire other information indicative of whether the code is authentic and make the determination at operation 206 based on that information as well.

The example depicted in FIG. 2D is similar to the example discussed in relation to FIG. 2C, but at operation 210 in addition to transmitting the acquired graphical code, a location at which the code was acquired (e.g., scanned or otherwise captured) is transmitted to the registry server 125. In examples, this may be accomplished by querying a geolocation function available on the mobile device 105 when the code is captured. At operation 212, authenticity information is received from the registry server 125 based on whether the graphical code 120 is registered and whether it is registered for a geographic region including the provided location. In examples, flow may proceed to operation 206 (and subsequent operations) of FIG. 2B, where a determination may be made as to the authenticity of the acquired code. In this example, the determination at operation 206 may include the application 110 adjusting a confidence value of an indication of authenticity based on whether the code was acquired in a location that is within a region for which the code was registered. In other examples, the location information of the acquired graphical code and the registered graphical code may be used by the registry server 125 in preparing an indication of authenticity that is returned to the application 110. In such examples, the information about whether the graphical code is registered for the location in which it was captured may not be returned to the application (as it would already be factored into the indication of authenticity). In other examples, the information about whether the graphical code is registered for the location in which it was captured may still be returned so that all relevant information is available for display to a user of the application 110 in order to make a decision whether or not to override any determination of authenticity.

In either case (whether the indication of authenticity is generated by the registry server 125 or by the application 110), the information based on which an indication of authenticity may be generated may include (i) whether the graphical code 120 is registered, (ii) whether the graphical code 120 is registered for a geographic region, and, if so, whether the geographic region includes the location of the graphical code 120 (iii) whether other graphical codes 120 are registered for geographic regions including the location of the graphical code, and, if so, whether they are registered by the same owner as the owner of the graphical code, and, if not, whether a determination of legitimately overlapping geographic regions (as in the case of businesses in a multi-story building, as described above) has been made (iv) whether indications of inauthenticity have been reported to the registry (e.g., during the registration/vetting process, or afterward), and (v) whether indications of authenticity have been reported to the registry (e.g., during the vetting process, or afterward).

In examples, if a graphical code 120 has not been registered it may be because it is inauthentic or because the owner is not aware of the registry or of how to register a graphical code. In such a case the indication of authenticity may be neutral, indicating little confidence that the graphical code 120 is authentic, and little confidence that the graphical code 120 is inauthentic. If, however, other graphical codes have been registered for a geographic region containing the graphical code, the indication of authenticity may be somewhat negative (e.g., an indication, with some confidence, that the graphical code 120 is inauthentic).

As another example, if the graphical code 120 has been registered for a relatively small geographic region (e.g., for a geographic region of one thousand, or ten thousand, square feet or less) including the location at which the graphical code 120 was acquired, and if no other graphical codes 120 have been registered for any geographic region including the location at which the graphical code 120 was acquired, then the indication of authenticity may be positive with relatively high confidence. In some embodiments, (i) the registry does not accept registrations for large geographic regions (e.g., for a metropolitan area, as discussed above) or (ii) registrations for geographic regions larger than a threshold size (e.g., for a geographic region greater than 100,000 square feet) are not taken into account when determining whether any other graphical codes are registered for a geographic region including the location of the graphical code 120 that was scanned.

In some embodiments, the indication of authenticity is greater when the graphical code is registered than when the graphical code is not registered, and the indication of authenticity is greater when the graphical code is registered for a region including the location than when the graphical code is registered and the graphical code is not registered for a region. In some embodiments, the indication of authenticity is greater when the graphical code is not registered and no graphical code is registered for a region including the location than when the graphical code is not registered and a graphical code is registered for a region including the location.

In some embodiments, encryption or a trusted electronic signature may be employed to generate an indication of authenticity. For example, a certification authority may (directly, or through secondary certification authorities), upon vetting of a graphical code 120 and its owner, generate a signed graphical code 120 which may be made available for users to scan. To generate a signed graphical code, the certification authority may generate a hash of the raw graphical code (e.g., of a URL), encrypt the hash using a private key of a suitable public key encryption method, and combine the raw graphical code 120 and the encrypted hash to form the signed graphical code. The application 110 may then, upon receiving a purportedly signed graphical code, calculate the hash of the raw graphical code, decrypt the hash using the public key corresponding to the private key, and compare the calculated hash to the decrypted hash. If the calculated has is the same as the decrypted hash, the application 110 may conclude that the raw graphical code 120 is authentic. A cryptographic signature may be an encrypted version of a hash of the clear-text. The private side of a public-private key-pair may be used to encrypt the hash, and the public side may be used to decrypt the hash. The private side can then be proven by the ability to decrypt with the public side and it is already known to all. The hash may be used to create a fixed-sized chunk of data, that is both long enough to be difficult to perform cryptographic attacks on, and also guaranteed short enough to include in a message. A cryptographic hash may be a checksum that is highly sensitive to changes in the input “clear-text” data. For example, a single bit change in the clear-text will result in a drastically different hash. FIG. 2E is a flowchart for such a method, in some embodiments. After a graphical code 120 is acquired, at 200, an indication of authenticity is generated, at 220, by determining whether the graphical code 120 is signed with a trusted signature. In examples, this may be accomplished by the application 110, as described above.

In this manner, an electronic signature may be used to assess authenticity instead of an inquiry made with a registry server 125, for example if access to the registry server 125 is not available. For example, the graphical code 120 may be an access string for a wireless network (e.g., the name of a WiFi network and credentials for accessing it), and, at the time that the access is to be made, the mobile device 105 may not have a connection to the internet (e.g., it may be for the purpose of connecting to the internet that the wireless network is being accessed). In some embodiments, each vetted graphical code 120 may be made a point in a block chain or distributed ledger type signed tree. A non-fungible token (NFT) may provide additional uniqueness for a given value. In some embodiments, the graphical code 120 may be a text string for a URL using a schema other than “http://”, e.g., it may be a purpose-created schema for use by the registry. The remainder of the URL in such a case may be a hash of a string identifying a resource (e.g., a hash of a URL to be accessed) and the registry may return the string, in addition to an indication of authenticity.

FIG. 2F may comprise a method performed by one or more registry servers 125 according to present embodiments. As discussed, registry server 125 may receive, at operation 230, a request to register a graphical code. In examples, the registration request may be received from graphical code provider system 130 and may include the graphical code, the name of the alleged owner of the graphical code, a registered location or area for the graphical code, etc. The geographic region may be one within which the graphical code 120 is expected to be found, and within which graphical codes 120 owned by other entities are not expected to be found. Graphical code providers may, for example, include a graphical region for which the graphical code provider desires to register the graphical code. For example, if a restaurant (a graphical code provider) registers a graphical code, it may register it for, e.g., a geographic region having a radius of 50 feet, centered on a point near the center of the restaurant. To submit a registration request for the graphical code, an employee of the restaurant may, for example, hold a mobile device (in this instance, graphical code provider system 130) at a point near the center of the restaurant and submit, to the registry server 125, a graphical code registration request using a registration application to (i) scan the graphical code, (ii) enter identifying information for the owner, (iii) provide a graphical code definition (defining the graphical code or defining a family of graphical codes 120 (as discussed), and (iv) provide a definition of a geographic region (e.g., by entering a radius, if the geographic region is to be defined as a circular region centered on the location of the mobile device). The registration application process performed using graphical code provider system 130 may be facilitated by an application resident on the graphical code provider system 130, by a portal hosted by registry server 125, or by any other means by which the necessary registration information may be communicated to the registry server 125 for a new or updated graphical code registration.

At operation 232, the registry server may determine an initial confidence value for the graphical code in the registration request. Various methods may be employed by the registry server 125 for determining an initial confidence value for a registration request before registering the associated graphical code(s) 120, to ensure reliability, and to reduce the likelihood that a malicious actor may register an inauthentic graphical code 120. For example, after the registration request is submitted, a third-party vetting service 140 may perform various checks (e.g., checks with financial institutions, checks of real estate records, site visits, or the like) to confirm that a purported owner of an asset (e.g., a restaurant or a parking meter) to be associated with a graphical code 120 is legitimate.

Further, as discussed, a geographic area for which the code is sought to be registered can be used in making the determination of an initial confidence value. For example, the registration of multiple graphical codes 120 to multiple respective owners with overlapping geographic regions may indicate that some or all of the graphical codes 120 are not authentic, and that information may be used in setting an initial confidence value. As another example, if the graphical code 120 has been registered for a relatively small geographic region (e.g., for a geographic region of one thousand, or ten thousand, square feet or less), and if no other graphical codes 120 have been registered for any geographic region including the location at which the graphical code 120 was acquired, then the indication of authenticity may be positive with relatively high confidence. In some embodiments, (i) the registry does not accept registrations for large geographic regions (e.g., for a metropolitan area, as discussed above) or (ii) registrations for geographic regions larger than a threshold size (e.g., for a geographic region greater than 100,000 square feet) are not taken into account when determining whether any other graphical codes are registered for a geographic region.

At operation 234, a determination is made with the initial confidence value exceeds a minimum confidence value for registration. For example, the registration server may be configured to reject (at operation 235) any registration attempt where the initial confidence value is below a predefined or user-defined threshold. In examples, operation 235 may also include storing, for some period of time, an indication of the graphical code for which registration was denied so that such a rejection list can be consulted by the registration server 125 when determining later if a received graphical code submitted for authentication is authentic.

If the initial confidence value exceeds the minimum threshold confidence value, flow proceeds to operation 236, where a data word and the initial confidence value are stored for the registered graphical code. The registry server 125 may store a plurality of data words, each corresponding to a graphical code, and, for each data word, data identifying the owner, and a geographic area, or “geographic region,” corresponding to the graphical code. Each registration in the registry maintained by registry server 125 may be for a single graphical code 120 or for a plurality, or “family” of related graphical codes. For example, a restaurant may register a different respective graphical code 120 for each table in the restaurant, so that when a customer places an order after navigating to a URL encoded in the graphical code 120, the web server receiving and processing the order may be aware of which table the order is to be delivered to. Similarly, in a parking lot with a plurality of parking meters (or with a plurality of parking spots, each having a graphical code 120 affixed to a sign at the parking spot) each parking spot may have a different respective graphical code. In such a situation, each graphical code 120 may include, for example, at the end of the URL, a variable-defining string such as “?tableNumber=5” or “?spotNumber=23”; this may inform the server, when a customer accesses the URL encoded in the graphical code 120, that the customer is at table 5 or has parked in parking spot 23, respectively. The family of graphical codes 120 with all possible valid values for the variable defined by the variable-defining string may be registered in a single registry entry. For example, wild cards may be included in a URL sent with a registration request by graphical code provider system 130, or the family of text strings to be registered may be represented as a regular expression, or the registry entry may be simply a domain, and the registry may be configured to consider as registered any URL within the domain (e.g., beginning with the name of the registered domain). In some embodiments, at the time of registration, the registry server 125 generates, returns to the graphical code provider system 130, and registers in the registry, a reduced-length data word (e.g., a reduced-length URL). It may also return to the graphical code provider system 130 a graphical code representing this reduced-length URL (or a signed graphical code representing this URL, as discussed above).

Flow proceeds to operation 238, where a request to verify an acquired graphical code is received. For example, as discussed, a registry server 125 may receive a request from application 110 to verify the authenticity of a graphical code 120 that was captured with camera 115. In examples, the request may include the graphical code 120 and an indication of a location where the graphical code was acquired.

Flow proceeds to operation 240, where a determination is made of authenticity information related to the acquired graphical code. As discussed, the authenticity information may include an indication of authenticity or information from which another device (such as mobile device 105) can determine an indication of authenticity. In determining the authenticity information for the acquired graphical code, the registry server may, for example, determine (a) whether the acquired graphical code appears in the current registry (or in the list of denied registration applications); (b) any stored initial confidence value for the corresponding registered graphical code; (c) if the acquired graphical code appears in the registry, whether it was registered with an intended geographic region and, if so, whether the location where the acquired graphical code was captured is within that region; (d) whether any other graphical codes are registered for the location where the acquired graphical code was captured; and (e) whether any reputation data is available for the acquired graphical code. In examples, the reputation data may include information available to the registration server 125 relating to interactions with that graphical code by other users. For example, a voting or rating system may be used, which may rely on input from users (e.g., users confirming successful interactions with certain graphical codes 120 through application 110, or users reporting that certain graphical codes 120 are inauthentic through application 110 or otherwise). In some examples, the registry server 125 may determine and store an updated confidence value for authenticity of the registered graphical code and store the updated value in addition to or instead of the initial confidence value for the registered graphical code that was determined during registration.

At operation 242, the authentication information for the acquired graphical code is provided. For example, as discussed, the registry server 125 may provide back to the application 110, an indication of authenticity or information available to the registry server 125 to allow the application 110 to make such determination of an indication of authenticity. If the registry server is determining an indication of authenticity to return to the application 110, the indication of authenticity may, for example, comprise the initial indication of authenticity from the registration process, modified by any updated information about the graphical code (e.g., reputation information) or information about where the graphical code was captured, as discussed above.

Embodiments described herein in the context of QR codes may be practiced with any other form of graphical code, such as a bar code, printed text (which may be scanned by the camera of a mobile device and converted from an image into text using optical character recognition), or other two-dimensional systems for encoding data into an image. As used herein, the graphical code that may be displayed for customers, any image of the graphical code, and the data word the graphical code translates to, are equivalent for most purposes, and are used interchangeably, in the present disclosure and claims. As such, for example, acquiring a data word encoded in a graphical code constitutes acquiring the graphical code, and transmitting a data word encoded in a graphical code constitutes transmitting the graphical code. As used herein, a “mobile device” is any portable computing device, e.g., a mobile telephone, a laptop computer, or a tablet computer.

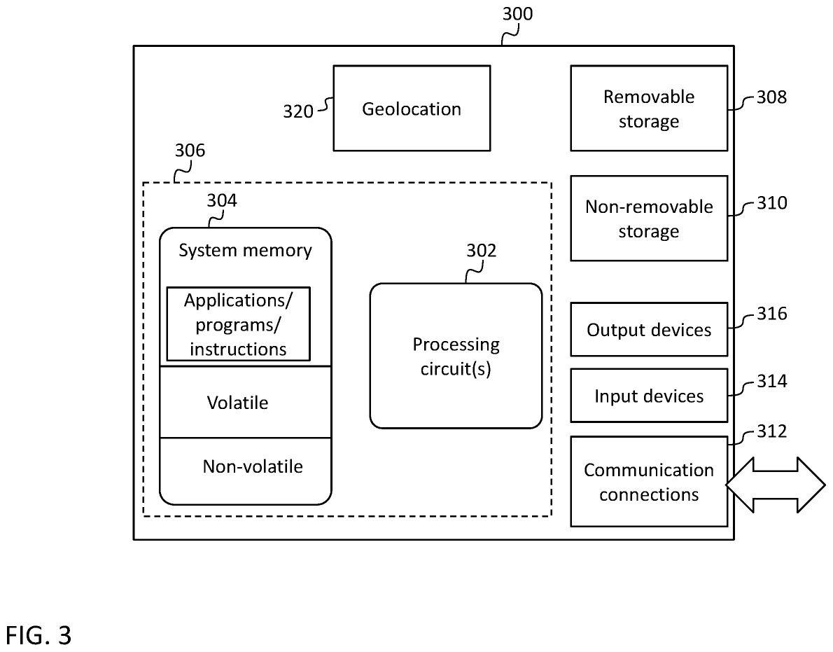

FIG. 3 depicts an example of a suitable operating environment 300 that may be used to implement the registry server 125, the mobile device 105, or other computing devices within the systems discussed herein. In its most basic configuration, operating environment 300 typically includes at least one processing circuit 302 and memory 304. The processing circuit may be a processor, which is hardware. Depending on the exact configuration and type of computing device, memory 304 (storing instructions to perform the methods disclosed herein) may be volatile (such as RAM), non-volatile (such as ROM, flash memory, etc.), or some combination of the two. This most basic configuration is illustrated in FIG. 3 by dashed line 306. The memory 304 stores instructions that, when executed by the processing circuit(s) 302, perform the processes and operations described herein. Further, environment 300 may also include storage devices (removable 308, or non-removable 310) including, but not limited to, solid-state, magnetic disks, optical disks, or tape. Similarly, environment 300 may also have input device(s) 314 such as keyboard, mouse, pen, voice input, etc., or output device(s) 316 such as a display, speakers, printer, etc. Additional communication connections 312 may also be included that allow for further communication with LAN, WAN, point-to-point, etc. Operating environment 300 may also include geolocation devices 320, such as a global positioning system (GPS) device.

Operating environment 300 typically includes at least some form of computer readable media. Computer readable media can be any available media that can be accessed by processing circuit 302 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information. Computer storage media is non-transitory and does not include communication media.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, microwave, and other wireless media. Combinations of any of the above should also be included within the scope of computer readable media.

As used herein, the word “or” is inclusive, so that, for example, “A or B” means any one of (i) A, (ii) B, and (iii) A and B. As used herein, when a method or a first quantity (e.g., a first variable) is referred to as being “based on” a second quantity (e.g., a second variable) it means that the second quantity is an input to the method or influences the first quantity, e.g., the second quantity may be an input (e.g., the only input, or one of several inputs) to a function that calculates the first quantity, or the first quantity may be equal to the second quantity, or the first quantity may be the same as (e.g., stored at the same location or locations in memory as) the second quantity. The term “processing circuit” is used herein to mean any combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general-purpose hardware, such as a CPU, configured to execute instructions stored in a non-transitory storage medium. A processing circuit may be fabricated on a single printed circuit board (PCB) or distributed over several interconnected PCBs. A processing circuit may contain other processing circuits; for example, a processing circuit may include two processing circuits, an FPGA and a CPU, interconnected on a PCB.

Although exemplary embodiments of a system and method for secure code scanning have been specifically described and illustrated herein, many modifications and variations will be apparent to those skilled in the art. Accordingly, it is to be understood that a system and method for secure code scanning constructed according to principles of this disclosure may be embodied other than as specifically described herein. The invention is also defined in the following claims, and equivalents thereof.

What is claimed is:

1. A method, comprising:
acquiring a graphical code;
transmitting the graphical code to a registry;
receiving authenticity information for the graphical code from the registry; and
using the authenticity information to perform an action.

2. The method of claim 1, wherein the acquiring of the graphical code comprises acquiring the graphical code with a camera of a mobile device.

3. The method of claim 2, wherein the graphical code is a Quick Response (QR) code.

4. The method of claim 1, wherein when the authenticity information indicates that the graphical code may be inauthentic, the action comprises presenting the indication in a user interface.

5. The method of claim 1, further comprising, when the authenticity information indicates that the graphical code is likely authentic, the action comprises automatically causing a browser to navigate to a website indicated by the graphical code.

6. The method of claim 1, wherein the authenticity information comprises an indication of whether the graphical code is registered.

7. The method of claim 6, further comprising transmitting to the registry a location where the graphical code was acquired, and the indication of whether the graphical code is registered is an indication of whether the graphical code is registered for a geographic region including the location.

8. The method of claim 7, further comprising receiving from the registry an indication of whether any graphical code is registered in a geographic region including the location.

9. The method of claim 8, further comprising generating an indication of authenticity, wherein the indication of authenticity is based on:
whether the graphical code is registered,
whether the graphical code is registered for a geographic region,
whether the graphical code is registered for a geographic region including the location, and
whether any other graphical code is registered for a geographic region including the location.

10. The method of claim 9, wherein the indication of authenticity is greater when the graphical code is registered than when the graphical code is not registered.

11. The method of claim 9, wherein the indication of authenticity is greater when the graphical code is registered for a geographic region including the location than when the graphical code is registered and the graphical code is not registered for a geographic region.

12. The method of claim 11, wherein the indication of authenticity is greater when the graphical code is not registered and no graphical code is registered for a geographic region including the location than when the graphical code is not registered and a graphical code is registered for a geographic region including the location.

13. The method of claim 1, wherein the graphical code is a Uniform Resource Locator (URL) or an access string for a wireless network.

14. A method, comprising:
acquiring a graphical code;
generating an indication of authenticity for the graphical code by determining whether the graphical code is signed with a trusted signature; and
using the indication of authenticity to perform an action.

15. A system, comprising:
at least one processor; and
memory, operatively connected to the at least one processor and storing instructions that, when executed by the at least one processor, cause the at least one processor to perform a method, the method comprising:
storing a registry of registered graphical codes;
receiving a request to verify an acquired graphical code; and
sending, in response to receiving the request to verify, authenticity information for the acquired graphical code.

16. The system of claim 15, wherein the authenticity information for the acquired graphical code comprises an indication of whether the acquired graphical code is registered as a registered graphical code in the registry.

17. The system of claim 15, wherein method further comprises receiving a registration request comprising a graphical code definition.

18. The system of claim 17, wherein the graphical code definition defines a family of graphical codes.

19. The system of claim 17, wherein the registration request further comprises an identifier for an owner and a definition of a geographic region.

20. The system of claim 19, wherein the request to verify includes a location where the acquired graphical code is captured, and wherein the method further comprises: determining the authenticity information for the acquired graphical code based on the graphical code definition, the identifier for the owner, the definition of the geographic region, and the location.
